(19) United States
(12) Patent Application Publication
(10) Pub. No.: US 2006/0254267 A1
(43) Pub. Date: Nov. 16, 2006

(54) Hydrodynamic torque converter

(75) Inventor: Stephan Maienschein, Baden-Baden (DE)

Correspondence Address: DAVIDSON, DAVIDSON & KAPPEL, LLC, 485 SEVENTH AVENUE, 14TH FLOOR, NEW YORK, NY, 10018, US

(73) Assignee: LuK Lamellen und Kupplungsbau Beteilgungs KG, Buehl (DE)

(21) Appl. No.: 11/406,715

(22) Filed: Apr. 19, 2006

(30) Foreign Application Priority Data
Apr. 20, 2005 (DE) 10 2005 018 223.2

(51) Int. Cl. F16D 33/00

(52) U.S. Cl. 60/345

(57) ABSTRACT

A hydrodynamic torque converter includes a housing-mounted impeller, a turbine that is torsionally fixed with respect to a transmission input shaft, and a stator braced by an axial bearing and supported on a freewheeling device between the impeller and the turbine. When attaching the torque converter to a transmission, the freewheel inner ring of the freewheel being slid in a torsionally fixed manner onto a non-rotating hollow stator shaft that is attached to the transmission housing, on the end face facing away from the hollow stator shaft, the freewheel inner ring has an internal shoulder which forms an assembly limit stop for the unattached end of the hollow stator shaft.

This application claims the benefit of German Patent Application No. 10 2005 018 223.2 filed Apr. 20, 2005 and hereby incorporated by reference herein.

The present invention provides a hydrodynamic torque converter, which has a housing-mounted impeller, a turbine that is torsionally fixed with respect to a transmission input shaft, and a stator braced by an axial bearing and supported on a freewheeling device between the impeller and the turbine, when attaching the converter to a transmission, the freewheel inner ring of the freewheel being slid in a torsionally fixed manner onto a non-rotating hollow stator shaft attached to the transmission housing.

### BACKGROUND

Hydrodynamic torque converters are primarily used for transmitting a torque from a crankshaft of an engine to a transmission input shaft. Within one housing, they accommodate a housing-mounted impeller, a turbine, and a stator. The torque converter is integrated in the hydraulic circuit of the transmission and is completely filled with hydraulic fluid during operation. At engine start-up, the crankshaft sets the housing of the torque converter into rotation, causing the impeller to move the hydraulic fluid in the direction of the turbine. This drives the turbine. The hydraulic fluid is subsequently moved in the direction of the stator and, in fact, oppositely to the direction of rotation of the impeller. The flow of the hydraulic fluid is diverted by the stator blades in the direction of rotation of the impeller, thereby improving the torque transmission efficiency of the torque converter. The energy of the fluid flow produces a torque in the turbine which is transmitted via the turbine hub to the transmission input shaft and, thus, to the transmission.

The stator is connected in a torsionally fixed manner to a freewheel outer ring of a freewheel, whose freewheel inner ring sits nonrotatably on the hollow stator shaft. The actual freewheeling mechanism is located between the freewheel outer ring and the freewheel inner ring. This permits the transmission of torque from the stator to the hollow stator shaft in one direction only. The stator typically engages with the hollow stator shaft via the freewheel, so that it is not able to rotate relative to the transmission housing. Torque can only be transmitted when there is slip between the impeller and the turbine that corresponds to the speed conversion. If the speed differential between the impeller and the turbine decreases due to external operating conditions and, thus, the speed conversion becomes greater, then the direction of flow incident on the stator changes, reversing the torque direction of the stator. Thus, the torque exerted at the turbine is less than that exerted at the impeller, which means that torque multiplication is no longer given. It is the function of the freewheel to prevent such an occurrence.

To achieve a trouble-free operation in automotive applications and the associated series production, all of the components of a torque converter must meet the highest quality requirements with respect to their manufacturing, as well as guidance and support. This also holds for the installation of the torque converter in the transmission. To this end, a pump neck formed on the impeller-side converter housing is first slid onto a guide bushing located on the hollow stator shaft of the transmission, the freewheel inner ring of the freewheel sliding at the same time onto the hollow stator shaft. For this purpose, the freewheel inner ring and the hollow stator shaft have a mutually corresponding multiple toothing which connects them nonrotatably, i.e., the freewheel inner ring has an internal toothing and, at the unattached end, the hollow stator shaft has a corresponding external toothing. During this installation step, it is absolutely necessary to protect critical transmission components from damage. Moreover, chips must be prevented from being shaved off by assembly-related angular displacement. Chips can seriously degrade the running properties of the transmission. An especially carefully executed and thus time-consuming placement of the torque converter on the hollow stator shaft of the transmission is impractical in a series assembly operation.

From the German Patent Application No. DE 197 56 684 A1 and related US Patent Publication No. 2004/0112698 which is hereby incorporated by reference herein, an automatic transmission is known which has a transmission housing, a torque converter, a guide bushing disposed between the torque converter and the hollow stator shaft, and a pump neck extending from the converter housing. To prevent the radial shaft seal from being damaged by a radial offset when the torque converter is slid onto the hollow stator shaft during the assembly process, in the mounting direction of the torque converter opposite the transmission housing, the guide bushing has a collar that extends at least partially over the periphery thereof, permitting precentering of the torque converter on the hollow stator shaft during assembly and thereby avoiding any radial offset of the pump neck. No provision is made for a retaining device to be used in the axial direction during installation.

To protect critical locations in the transmission from damage during installation of the torque converter and to prevent chips from being shaved off by assembly-related angular displacement, it is already known to provide an external collar on the hollow stator shaft to form an axial limit stop on a component of the torque converter during the process of preassembling the same. Thus, the torque converter can be inserted only so far into the transmission housing until it makes contact with the external collar of the hollow stator shaft. If the external collar strikes against the side of the freewheel inner ring facing the hollow stator shaft, for example, then the further benefit is derived that there are no points of contact in relative motion between the torque converter and the transmission, since the freewheel inner ring does, in fact, sit in a rotationally fixed manner on the likewise non-rotating hollow stator shaft. The disadvantage here, however, is the outlay required for the additional external collar when manufacturing the hollow stator shaft. Moreover, an external collar narrows the flow cross-section between the pump neck and the hollow stator shaft, necessitating follow-up measures in terms of structural design. In addition, this design approach, which provides for using a limit stop on the converter side, is highly inflexible, since it requires fixing the position of the freewheel inner ring already at the initial design stage. Any modifications that became necessary later on would be very expensive, since adjoining components would have to be modified as well.

It is also known to provide a limit stop between the hub of the turbine and the end face of the hollow stator shaft (DE 103 52 963 A1), eliminating the need for a special collar. However, this typically entails the disadvantage of a greater amount of material used and the higher weight associated with the same, and of unavoidable relative motion at the contact point between the turbine hub and the hollow stator shaft.

### SUMMARY OF THE INVENTION

Therefore, in order to avoid damage and the formation of chips during the process of preassembling the torque converter, an object of the present invention provides an axial limit stop for the hollow stator shaft which may do without any additional outlay for material or production engineering, may not entail any disadvantages in terms of hydraulics, may not result in any loss of flexibility in the structural design of a torque converter, and/or may not pose the risk of damage from the effects of cutting and friction caused by relative motion at the point of contact with the hollow stator shaft.

The present invention provides a torque converter where on the end face facing away from the hollow stator shaft, the freewheel inner ring has an internal shoulder which forms an assembly limit stop for the unattached end of the hollow stator shaft.

In comparison to a conventional freewheel inner ring, the freewheel inner ring designed in accordance with the present invention may able to be manufactured without a collar and without requiring any additional outlay. It may be manufactured, for example, in a compression-molding process, such as reverse extrusion, or in a sintering process. The amount of additional material required for the internal shoulder may be very negligible and may be less than that which would be have to be added for an external collar on the hollow stator shaft. Moreover, the internal shoulder may not affect the flow cross-section between the pump neck and the hollow stator shaft. Also, it may not be possible for any relative motion to come about between the freewheel inner ring and the hollow stator shaft; and the position of the freewheel inner ring may not need to be specified already at the initial design stage.

### BRIEF DESCRIPTION OF THE DRAWINGS

The present invention is explained in greater detail below on the basis of an exemplary embodiment, reference being made to the corresponding drawings, in which:

FIG. 1 shows a partial cross section at the coupling point between a torque converter and a vehicle transmission; and

FIGS. 2 and 3 illustrate a freewheel inner ring in a radial and axial section.

### DETAILED DESCRIPTION OF A PREFERRED EMBODIMENT

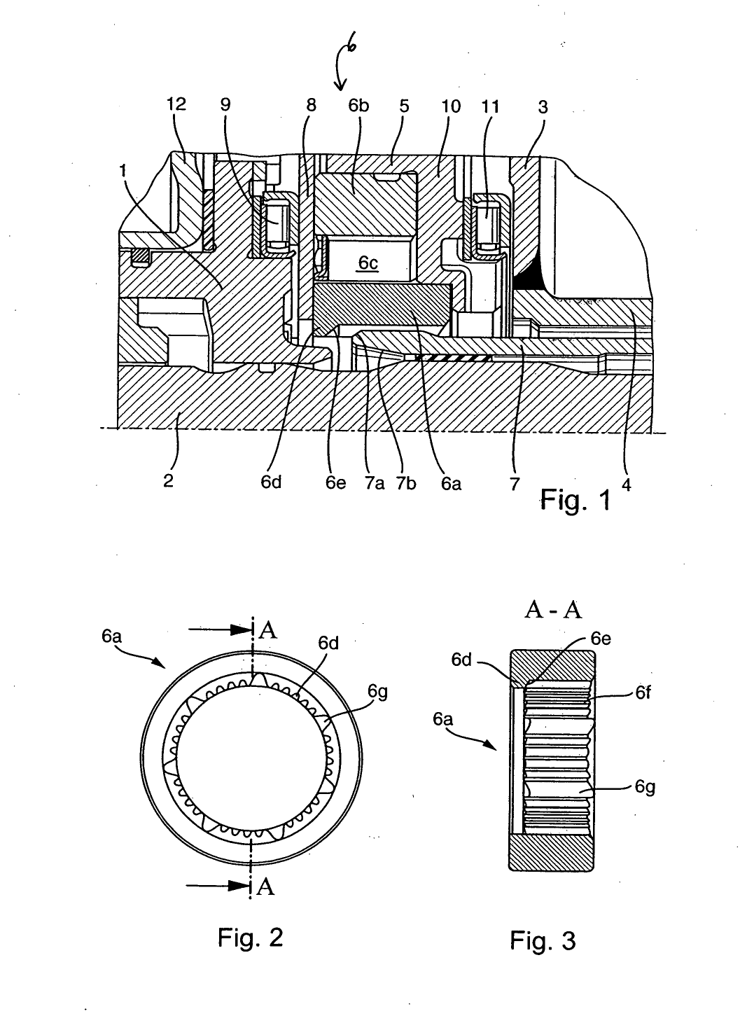

In FIG. 1, the cut-away portion reveals a turbine hub 1 of an only partially represented torque converter, which, radially outwardly, supports a turbine, whose torque is transmitted via turbine hub 1 to transmission input shaft 2 and, thus, to a transmission. Schematically illustrated opposite turbine hub 1 is an outer shell 3 of an impeller, from which a pump neck 4 extends in the direction of the transmission and is rotatably and sealingly supportable in the transmission housing. Outer shell 3 of the impeller is welded to an engine-side housing shell 12 of the torque converter to form a toroidal-type housing which encloses the torque converter in a fluid tight manner, pump neck 4 terminating at the transmission housing. Disposed nonrotatably between outer shell 3 of the impeller and an inner shell of the impeller are vane segments, which make up the impeller, which, in response to rotation, drive a fluid flow inside of the torque converter which, in turn, drives the turbine, which, in the same way as the impeller, features an outer shell and an inner shell, between which blades are attached. Secured radially inwardly between the impeller and the turbine, on a stator hub 5, is a stator, which likewise features an outer shell, an inner shell, and blades attached therebetween. The stator hub 5 is operatively connected via a freewheel 6 to stationary hollow stator shaft 7 in order to divert the hydraulic fluid from the turbine to the impeller.

Freewheel 6 is composed of a freewheel inner ring 6a, a freewheel outer ring 6b, and an actual freewheel coupling mechanism 6c located between freewheel inner ring 6a and freewheel outer ring 6b. The end faces of freewheel inner ring 6a and of freewheel outer ring 6b on the engine side are in contact with a limit stop 8 which is braced by turbine hub 1 via an axial roller bearing 9. The end faces of freewheel inner ring 6a and of freewheel outer ring 6b on the transmission side are in contact with an axial thrust support 10 of stator hub 5 which is braced by pump neck 4 via an additional axial roller bearing 11. In this manner, the axial motion of stator hub 5, along with the stator, between turbine hub 1 and pump neck 4 is limited by axial roller bearings 9, 11. On its inside circumference, freewheel inner ring 6a has an internal toothing for engaging with an outer toothing on the outer circumference of the unattached end of hollow stator shaft 7. Freewheel outer ring 6b is secured to the inner peripheral region of stator hub 5, for example by caulking. Freewheel coupling mechanism 6c, for example a rolling element mechanism, permits rotation of the stator in only one direction.

In accordance with the present invention, on the engine side, freewheel inner ring 6a has an internal shoulder 6d integrally formed thereon. Since, viewed in the axial direction, freewheel inner ring 6a is often intrinsically longer than freewheel outer ring 6b, shoulder 6d does not adversely affect the torsional strength of the connection between freewheel inner ring 6a and hollow stator shaft 7.

To mount the torque converter on the transmission that is already installed in the motor vehicle, it is inserted by way of the pump neck 4 into a bearing of the transmission housing, it also being necessary for the inner toothing of freewheel inner ring 6a to meet with the outer toothing on hollow stator shaft 7. In the preassembly process, internal shoulder 6d is used as an assembly limit stop for the end face of the unattached end of hollow stator shaft 7. In this way, installation damage, that could occur by inserting the torque converter too far into the transmission, is effectively avoided, while, at the same time, minimal expenditure is required.

A chamfer 7a on the end face of hollow stator shaft 7 that is useful for locating hollow stator shaft 7 in freewheel inner ring 6a during the slip-on process corresponds with a chamfer 6e on internal shoulder 6d of freewheel inner ring 6a. In another embodiment, hollow stator shaft 7 features an internal taper 7b at the end face to prevent turbine hub 1 from striking the unattached end face of hollow stator shaft 7.

In FIGS. 2 and 3, the freewheel inner ring according to the present invention is shown in detail in a radial and axial section. Position 6d denotes the internal shoulder. On the inner side of internal shoulder 6d, 6e denotes the chamfer which is the maximum hollow stator shaft 7 can abut against during preassembly of the torque converter. The toothing on the inner circumference of freewheel inner ring 6a is made up of flatter and deeper wedge-shaped notches 6f, 6g distributed over the inner circumference. The tooth pitch on hollow stator shaft 7 is designed to conform with this.

### REFERENCE NUMERAL LIST

1 turbine hub
2 transmission input shaft
3 outer shell of impeller
4 pump neck
5 stator hub
6 freewheel
6a freewheel inner ring
6b freewheel outer ring
6c freewheel coupling mechanism
6d internal shoulder on freewheel inner ring
6e chamfer on internal shoulder
6f flat wedge-shaped notches
6g deep wedge-shaped notches
7 hollow stator shaft
7a chamfer on the end face of hollow stator shaft
7b internal taper on the end face of hollow stator shaft
8 limit stop
9 axial roller bearing
10 axial thrust support
11 axial roller bearing
12 engine-side housing shell

What is claimed is:

1. A hydrodynamic torque converter comprising:
a housing-mounted impeller;
a turbine torsionally fixed with respect to a transmission input shaft;
a freewheel between the impeller and the turbine, the freewheel having an inner ring;
a stator braced by an axial bearing and supported on the freewheel; and
a non-rotating hollow stator shaft being attached to a transmission housing;
the freewheel inner ring capable of being slid in a torsionally fixed manner onto the non-rotating hollow stator shaft when attaching the torque converter to a transmission;
the freewheel inner ring having an internal shoulder on an end face facing away from the hollow stator shaft;
the internal shoulder forming an assembly limit stop for an unattached end of the hollow stator shaft.

2. The hydrodynamic torque converter as recited in claim 1 wherein the freewheel inner ring has an internal toothing up to a level of the internal shoulder engaging a corresponding external toothing on the hollow stator shaft in an assembled state of the torque converter.

3. The hydrodynamic torque converter as recited in claim 1 wherein the internal shoulder has a chamfer corresponding with a chamfer on a face of the end of the hollow stator shaft.

4. The hydrodynamic torque converter as recited in claim 1 wherein the freewheel inner ring acts via a freewheeling mechanism on a freewheel outer ring, the freewheel outer ring being caulked to a stator hub.

5. The hydrodynamic torque converter as recited in claim 1 wherein an axial length of the freewheel inner ring is greater than an axial length of a freewheel outer ring.

6. The hydrodynamic torque converter as recited in claim 1 wherein the freewheel inner ring is compression-molded or sintered.

7. The hydrodynamic torque converter as recited in claim 1 wherein the hollow stator shaft has an internal taper to prevent a turbine hub from striking against the unattached end of the hollow stator shaft.

8. The hydrodynamic torque converter as recited in claim 1 wherein the freewheel is held in an axial direction between an axial thrust support of a stator hub and a limit stop.

9. A method for installing a hydrodynamic torque converter having a housing-mounted impeller; a turbine torsionally fixed with respect to a transmission input shaft; a freewheel between the impeller and the turbine, the freewheel having an inner ring; a stator braced by an axial bearing and supported on the freewheel; and a non-rotating hollow stator shaft being attached to a transmission housing; the freewheel inner ring having an internal shoulder on an end face facing away from the hollow stator shaft, the method comprising:
sliding the freewheel inner ring in a torsionally fixed manner onto the non-rotating hollow-stator shaft to attach the torque converter to a transmission, the internal should functioning as an assembly limit stop for an unattached end of the hollow stator shaft.
